(19) United States
(12) Patent Application Publication
(10) Pub. No.: US 2008/0202478 A1
(43) Pub. Date: Aug. 28, 2008

(54) Pressure Control Valve for a Hydraulic Device, and Use of Said Pressure Control Valve

(75) Inventors: Dirk Möhring, Schwalbach am Taunus (DE); Rene Schmid, Frankfurt/Main (DE); Alexander Sonntag, Schwalbach (DE); Hans-Dieter Wilhelm, Darmstadt (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens Aktiengesellschaft, Munich (DE)

(21) Appl. No.: 10/588,822

(22) PCT Filed: Jan. 5, 2005
(86) PCT No.: PCT/EP2005/050036

§ 371 Date: Jan. 22, 2008

(30) Foreign Application Priority Data
Feb. 17, 2004 (DE) 10 2004 007 662.6

(51) Int. Cl. F16K 15/04; F16K 17/04; F16K 17/06

(52) U.S. Cl. 123/514; 137/539.5

(57) ABSTRACT

Disclosed is a pressure control valve (8) for a hydraulic device, particularly a fuel supply system of a motor vehicle, comprising a valve seat (10) that is disposed between a valve member (13) and a spring element (16) for biasing the valve member (13) counter to the valve seat (10). The valve member (13) and the spring element (16) are interconnected via a traction element (14) such that the valve member (13) is reliably guided towards the valve seat (10) without using any additional guiding elements.

The invention relates to a pressure control valve for a hydraulic device, having a valve body which is prestressed against a valve seat, and having a spring element for prestressing the valve body. The invention also relates to an advantageous use of the pressure control valve.

Pressure control valves are often used in hydraulic devices for the purpose of removing excess pressure from a tank or a line, and are known in practice. In the case of the pressure control valve which is known in practice, the spring element is arranged on the lower-pressure side. If there is an increase in pressure on that side of the valve body which is directed away from the spring element, the valve body is pushed away from the valve seat counter to the force of the spring element. The pressure at which the known pressure control valve opens is dependent on the pressure difference on the two sides of the valve body and the spring force.

The disadvantage with the known pressure control valve is that the valve body requires a lateral guide in order to be guided reliably back on to the valve seat by the spring element. The lateral valve, however, is costly to produce and causes friction. Such friction results in fluctuating opening and closing pressures and in a fluctuation in the characteristic curve over the breakaway flow which is channeled away by the pressure control valve. Furthermore, the known pressure control valve has particularly high levels of noise emission.

The problem on which the invention is based is to configure a pressure control valve of the type mentioned in the introduction such that it has a shallow characteristic curve and has the lowest possible levels of noise emission. It is also intended to provide for an advantageous use of the pressure control valve.

The first-mentioned problem is solved according to the invention in that the spring element is arranged downstream of the valve seat, as seen from the valve body, and in that the valve body and the spring element are connected to one another via a pulling element.

By virtue of this configuration, the spring element is arranged on the higher-pressure side and pulls the valve body against the valve seat. Lateral valve-body guides are thus avoided, and friction of the valve body is kept to a particularly low level. The pressure control valve according to the invention thus has a particularly shallow characteristic curve. In addition, the pressure control valve according to the invention does not require any housing parts on the valve-body side and can thus be produced particularly cost-effectively. Furthermore, the pressure control valve according to the invention has a higher level of stability and thus low levels of noise emission.

In order to reduce the valve-body vibrations, it is beneficial if a control inlet is arranged transversely to the movement direction of the valve body. This configuration avoids direct axial flow against the valve body.

The pressure control valve according to the invention has a particularly high level of stability if the pulling element is designed as a rod which connects the valve body to a retaining body.

The spring element could be designed, for example, as a tension spring. In order further to increase the stability of the pressure control valve according to the invention, however, it is beneficial if the spring element is designed as a compression spring and is supported on the retaining body and a component connected to the valve seat.

The task of installing the pressure control valve according to the invention in the hydraulic device requires particularly low outlay if the component having the valve seat, the valve body, the spring element and the pulling element form a preassemblable structural unit.

In order further to simplify the task of installing the pressure control valve according to the invention, it is beneficial if the component having the valve seat has latching hooks on its outer lateral surface. As a result, the pressure control valve can easily be pushed, for example, into a plastic housing and is retained by the latching hooks. The lateral surface preferably has a row of latching hooks and thus has a fir-tree profile.

The opening pressure of the pressure control valve according to the invention can easily be set by plastic deformation of the retaining body if the retaining body is designed as a calibrating disc, and if the calibrating disc is of deformable configuration for the purpose of setting the spring force to which the valve body is subjected.

Basic setting of the pressure control valve to the pressure envisaged preferably takes place by using an appropriately dimensioned spring element.

In order further to simplify the task of installing the pressure control valve according to the invention, it is beneficial if the retaining body is pressed together with the pulling element.

Setting the spring force and thus the opening pressure of the pressure control valve according to the invention requires particularly low outlay if it is possible to adjust the position of the retaining body on the pulling element and/or the spring element.

The valve body can be produced particularly cost-effectively, according to another advantageous development of the invention, if the valve body is of spherical configuration. Furthermore, when the pressure control valve is open, the valve body is thus retained in the central position in relation to the valve seat by the flow and is pulled reliably against the valve seat by the spring element. The valve body is thus self-centering in relation to the valve seat. The pressure control valve according to the invention therefore does not require any high-outlay guide elements for the valve body.

In order further to reduce the levels of noise emission of the pressure control valve according to the invention, it is beneficial, according to another advantageous development of the invention, if the valve body has a directing element which is spaced apart from its abutment surface on the valve seat and is arranged transversely to the flow direction. In the simplest case, the directing element is a flattened portion of the valve body. This results in a separation of the flow on the valve body.

In order further to simplify the production of the valve body, it is beneficial, according to another advantageous development of the invention, if the directing element is of annular configuration and is connected to the valve body. An additional force is thus introduced into the valve body. This results in a particularly shallow characteristic curve of the pressure control valve according to the invention.

In order further to simplify the task of installing the pressure control valve according to the invention, it is beneficial if the directing element has a smaller external diameter than the component having the valve seat. It is thus possible for the pressure control valve according to the invention to be installed in a recess of the hydraulic device with the valve body in front.

Flow separation and thus vortexing upstream of the valve seat can easily be avoided, according to another advantageous development of the invention, if the valve seat, as seen in cross section, has an arcuate contour which mates with the valve body. This results in a particularly small all-round gap length when the pressure control valve is open. The negative pressure which arises in the case of flow through the valve is therefore particularly small, which results in the valve body tending toward low intake levels. In the most favorable case, the valve body is in linear contact with the valve seat.

The valve seat could be, for example, of elastomeric configuration. However, this results in hysteresis during opening and closing of the pressure control valve. The pressure control valve according to the invention makes a particularly small breakaway quantity possible if the valve seat is of non-elastic configuration. Furthermore, the valve seat may thus be produced integrally with the retaining part. This configuration also allows high surface contact pressure on the valve seat.

The task of installing the control valve according to the invention is particularly straightforward if the retaining part is inserted with sealing action in a housing connector, and if a control inlet is arranged upstream of the spring element as seen in the flow direction.

The second-mentioned problem is solved according to the invention by the use of the pressure control valve in a fuel supply system of a motor vehicle for the purpose of limiting a pressure within a vessel located in a fuel tank.

It is often necessary, in the case of fuel supply systems of motor vehicles, to keep constant a pressure, for example, in a fuel line leading to an internal combustion engine, upstream of a suction jet pump or in a filter housing. The vessel located within the fuel tank may thus optionally be a line or a housing. The configuration of the pressure control valve makes it possible to have particularly small fluctuations in the opening and closing pressure in dependence on the breakaway flow. Furthermore, the fuel supply systems of motor vehicles are mass-produced in large numbers, so that doing away with the guides for the valve body is highly advantageous in terms of costs.

Numerous embodiments are made possible by the invention. In order to clarify the basic principle of the invention further, two of these embodiments are described hereinbelow and are illustrated in the drawing, in which

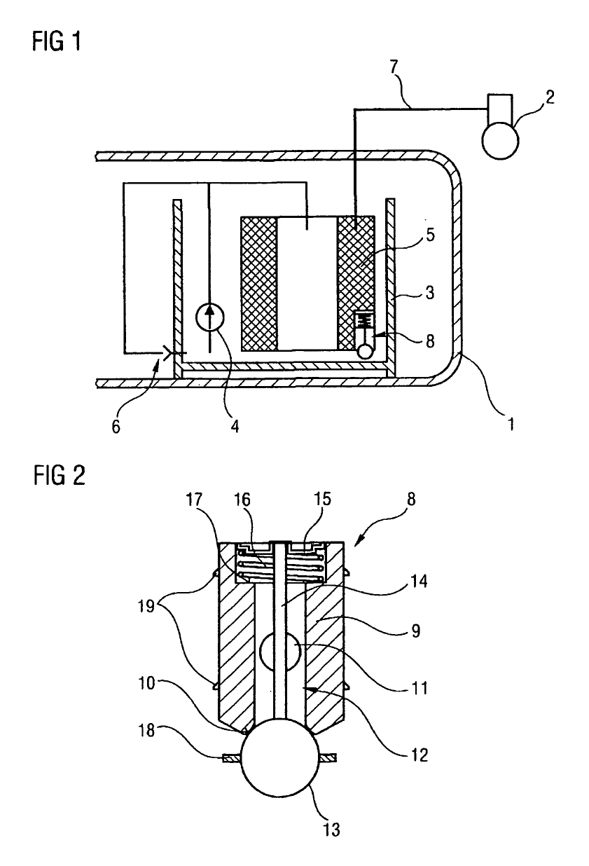

FIG. 1 shows, schematically a sectional illustration of a fuel supply system of a motor vehicle with a pressure control valve according to the invention,

FIG. 2 shows, on a vastly enlarged scale, a sectional illustration of the pressure control valve from FIG. 1,

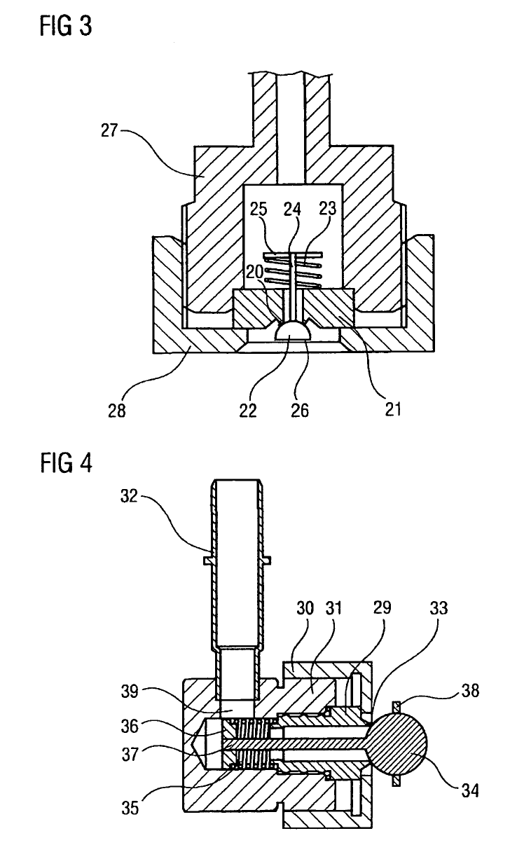

FIG. 3 shows a further embodiment of the pressure control valve according to the invention, and

FIG. 4 shows a further embodiment of the pressure control valve according to the invention.

FIG. 1 shows a fuel tank 1 of a motor vehicle and also an internal combustion engine 2. The fuel tank 1 contains a surge chamber 3 with a fuel pump 4 arranged therein. The fuel pump 4 feeds fuel from the surge chamber 3 to a fuel filter 5, designed as an annular filter, and to a suction jet pump 6. The suction jet pump 6 feeds fuel from the fuel tank 1 into the surge chamber 3. A fuel line 7 leads from the fuel filter 5 to the internal combustion engine 2. The fuel filter 5 also has a pressure control valve 8 which opens in the presence of an envisaged pressure within the fuel filter 5 and allows fuel to flow off into the surge chamber 3.

FIG. 2 shows a sectional illustration of the pressure control valve 8 from FIG. 1. The pressure control valve 8 has a housing 9 with a valve seat 10 and with a control inlet 11. The control inlet 11 opens out into a channel 12 leading to the valve seat 10. In that position of the pressure control valve 8 which is illustrated, the valve seat 10 is closed by a spherical valve body 13. The valve seat 10 surrounds the spherical valve body 13 and, as seen in cross section, has an arcuate contour which mates with the valve body. The valve body 13 is connected to a retaining body 15 via a pulling element 14. One end of a spring element 16 is supported on the retaining body 15. The spring element 16 has its other end supported on a shoulder 17 of the housing 9. The retaining body 15 is designed as a calibrating disc and is pressed together with the pulling element 14 which is designed as a rod. In order to adjust the spring force and thus the prestressing of the valve body 13 against the valve seat 10, it is possible for the retaining body 15, in the first instance to be fastened on the pulling element 14 in an envisaged position and then to be plastically deformed. An annular directing element 18 is fastened on the valve body 13. Latching hooks 19 are arranged on the outer lateral surface of the housing 9 and allow the pressure control valve 8 to be fastened in the fuel filter 5, which is illustrated in FIG. 1. The pressure control valve 8 is thus designed as a structural unit comprising the housing 9 with valve seat 10, spring element 16 and valve body 13, and, for installation purposes, can be pressed into a bore.

FIG. 3 shows a sectional illustration of a further embodiment of the pressure control valve 8 from FIG. 1. The pressure control valve 8 has a structural unit comprising a retaining part 21, which has a valve seat 20, and also comprising a valve body 22 and a pulling element 24, which connects the valve body 22 to a spring element 23. Arranged at the free end of the pulling element 24 is a retaining body 25 for connecting to the spring element 23. The valve body 22 is of spherical configuration on its side which is directed toward the valve seat 20 and, on its side which is directed away from the valve seat 20, it has a flattened portion which is designed as a directing element 26 and is intended for deflecting the flow. The structural unit is clamped in between a housing connector 27 and a cap nut 28 screwed onto the housing connector 27.

FIG. 4 shows a further embodiment of the pressure control valve from FIG. 1, in the case of which a retaining part 29 is prestressed against a housing connector 31 by a cap nut 30. A tubular connection stub 32 is soldered to the housing connector 31. The retaining part 29 has a valve seat 33, against which a valve body 34 is prestressed. A spring element 35 is supported at that end of the retaining part 29 which is directed away from the valve seat 33. The spring element 35 prestresses a retaining body 36. The retaining body 36 is connected to the valve body 34 via a pulling element 37. As in the case of the embodiment according to FIG. 2, the valve body 34 is of spherical configuration and has an annular directing element 38. In contrast to the embodiment according to FIG. 2, a control inlet 39 is arranged in the housing connector 31, upstream of the spring element 35. A medium flowing through the pressure control valve is thus guided by way of coils of the spring element 35. As with the embodiment according to FIG. 2, the valve seat 33 surrounds the spherical valve body 34 and has an arcuate contour in cross section.

1. A pressure control valve for a hydraulic device, having a valve body which is prestressed against a valve seat, and having a spring element for prestressing the valve body, characterized in that the spring element (16, 23, 35) is arranged downstream of the valve seat (10, 20, 33), as seen from the valve body (13, 22, 34), and in that the valve body (13, 22, 34) and the spring element (16, 23, 35) are connected to one another via a pulling element (14, 24, 37).

2. The pressure control valve as claimed in claim 1, characterized in that a control inlet (11) is arranged transversely to the movement direction of the valve body (13, 34).

3. The pressure control valve as claimed in claim 1 or 2, characterized in that the pulling element (14, 24, 37) is designed as a rod which connects the valve body (13, 22, 34) to a retaining body (15, 25, 36).

4. The pressure control valve as defined in claim 1, characterized in that the spring element (16, 23, 35) is designed as a compression spring and is supported on the retaining body (15, 25, 36) and a component connected to the valve seat (10, 20, 33).

5. The pressure control valve as defined in claim 1, characterized in that the component having the valve seat (10, 20, 33), the valve body (13, 22, 34), the spring element (16, 23, 35) and the pulling element (14, 24, 37) form a preassemblable structural unit.

6. The pressure control valve as defined in claim 1, characterized in that the component having the valve seat (10) has latching hooks (19) on its outer lateral surface.

7. The pressure control valve as defined in claim 3, characterized in that the retaining body (15, 25, 36) is designed as a calibrating disc, and in that the calibrating disc is of deformable configuration for the purpose of setting the spring force to which the valve body (13, 22, 34) is subjected.

8. The pressure control valve as defined in claim 3, characterized in that the retaining body (15, 25, 36) is pressed together with the pulling element (14, 24, 37).

9. The pressure control valve as defined in claim 3, characterized in that it is possible to adjust the position of the retaining body (15, 25, 36) on the pulling element (14, 24, 37) and/or the spring element (16, 23, 35).

10. The pressure control valve as defined in claim 1, characterized in that the valve body (13, 34) is of spherical configuration.

11. The pressure control valve as defined in claim 1, characterized in that the valve body (13, 22, 34) has a directing element (18, 26, 38) which is spaced apart from its abutment surface on the valve seat (10, 20, 33) and is arranged transversely to the flow direction.

12. The pressure control valve as defined in claim 11, characterized in that the directing element (18, 38) is of annular configuration and is connected to the valve body (13, 34).

13. The pressure control valve as defined in claim 11, characterized in that the directing element (18, 26, 38) has a smaller external diameter than the component having the valve seat (10, 20, 33).

14. The pressure control valve as defined in claim 1, characterized in that the valve seat (10, 20, 33), as seen in cross section, has an arcuate contour which mates with the valve body (13, 22, 34).

15. The pressure control valve as defined in claim 1, characterized in that the valve seat (10, 20, 33) is of non-elastic configuration.

16. The pressure control valve as defined in claim 1, characterized in that the retaining part (21, 29) is inserted with sealing action in a housing connector (27, 31), and in that a control inlet (39) is arranged upstream of the spring element (23, 25), as seen in the flow direction.

17. Use of the pressure control valve as defined in claim 1 in a fuel supply system of a motor vehicle for the purpose of limiting a pressure within a vessel located in a fuel tank.
